(19) United States
(12) Patent Application Publication
(10) Pub. No.: US 2023/0255182 A1
(43) Pub. Date: Aug. 17, 2023

(54) Dog Leash with Article Hold Section

(71) Applicant: Ronald Nelson Myers, San Diego, CA (US)

(72) Inventor: Ronald Nelson Myers, San Diego, CA (US)

(21) Appl. No.: 17/670,266

(22) Filed: Feb. 11, 2022

(51) Int. Cl. A01K 27/00

(52) U.S. Cl. CPC A01K 27/003; A01K 27/008

(57) ABSTRACT

A leash has a length of material folded back at a first end and joined to itself, forming a loop having an inside surface rounded on one side and converging to a point on an opposite side, with leash material extending from the loop to a second end, a clasp mechanism joined at the second end, adapted to clip to a collar or a harness of an animal, and a closure mechanism implemented in the loop, adapted to urge one side of the inside surface of the loop for a closure distance from the pointed end to the rounded end into intimate contact with a second side of the inside surface of the loop for the closure distance.

### BACKGROUND OF THE INVENTION

### 1. Field of the Invention

The present invention is in the field of animal leashes and harnesses pertaining particularly to methods and apparatus for holding one or more articles suspended on the dog leash.

### 2. Discussion of the State of the Art

In the art of animal leashes and harnesses, a market exists for pet leashes or leash/harness combinations suited for walking pets such as dogs, for example. Dog leashes are available in varying forms, for example, leather or fabric leashes of specific lengths and widths, typically including a leash loop at one end and a carabiner or spring latch mechanism at the other end for clipping the end of the leash to a ring on a dog collar or loop on a harness. Retractable wire leashes are available in the art, however most experts recommend a shorter non-retractable leash of perhaps 15 feet maximum in length for the safety of the dog and dog owner.

In many areas including public areas, dog parks, and neighborhoods, the responsibility of the owner walking a dog is to pick up after the dog. Plastic bags are typically used to collect dog feces and bag it until it can be disposed of properly. Many dog owners may carry one or more doggie bags for some time before a place to dispose of them is reached causing an inconvenience to the dog owner.

Therefore, what is clearly needed is a leash that may serve the function of carrying doggie bags or other relatively lightweight items while walking a dog or other animal.

### BRIEF SUMMARY OF THE INVENTION

In an embodiment of the present invention a leash is provided, comprising a length of leash material folded back at a first end and joined to itself, forming a loop having an inside surface rounded on one side and converging to a point on an opposite side, with leash material extending from the loop to a second end, a clasp mechanism joined at the second end, adapted to clip to a collar or a harness of an animal, and a closure mechanism implemented in the loop, adapted to urge one side of the inside surface of the loop for a closure distance from the pointed end to the rounded end into intimate contact with a second side of the inside surface of the loop for the closure distance. The leash is characterized in that a user of the leash is enabled to open the first and second sides of the inside surface of the loop, place an article between the open sides, and to close the sides again around the article, holding the article suspended, and is enabled to open the sides of the inside surface of the loop to remove the suspended article.

In one embodiment the closure mechanism comprises a strip of hook fastener material joined to the first side of the inside surface of the loop, and a strip of loop fastener material joined to the second side of the inside surface of the loop, wherein the opening and closing is accomplished by the action of the hook and loop fastener material strips. Also, in one embodiment the strips of hook and loop faster material are joined to the first and second sides of the inside surface of the loop by stitching. In one embodiment the strips of hook and loop faster material are joined to the first and second sides of the inside surface of the loop by a strong adhesive. And in one embodiment the closure mechanism comprises a spring metal clip having a first metal side and a second metal side in parallel intimate contact for a closure length from a first end to a second end, the first metal side and the second metal side joined together at the first end and open at the second end, the spring metal clip joined to the first and second sides of the inside surface of the loop with the first end at the pointed side of the loop and the open second end toward the rounded side of the loop.

In one embodiment of the invention the spring metal clip is joined to the first and second sides of the inside surface of the loop by a strong adhesive. Also, in one embodiment the first metal side and the second metal side of the spring metal clip are joined at the first end by welding. Also, in one embodiment the first metal side and the second metal side of the spring metal clip are a single strip of spring steel folded at the first end forming the two metal sides in parallel intimate contact. In one embodiment the metal sides of the spring metal clip at the open-end curve away from one another providing a lead in enabling a user to urge a portion of an article into the open end to be held between the metal sides. And in one embodiment one metal side of the spring metal clip is formed to provide a hold feature, such that the portion of an article urged between the metal sides is caught at the hold feature.

In another aspect of the invention a method for carrying an article with a leash is provided, comprising forming a leash by folding a length of leash material back at a first end and joining the first end to the leash material, forming a loop having an inside surface rounded on one side and converging to a point on an opposite side, with leash material extending from the loop to a second end, attaching a clasp mechanism at a second end, adapted to clip to a collar or a harness of an animal, implementing a closure mechanism in the loop, the closure mechanism adapted to urge one side of the inside surface of the loop for a closure distance from the pointed end to the rounded end into intimate contact with a second side of the inside surface of the loop for the closure distance, opening the first and second sides of the inside surface of the loop, placing a portion of an article between the open sides, and closing the sides again around the article, holding the article suspended.

In one embodiment of the method the closure mechanism comprises a strip of hook fastener material joined to the first side of the inside surface of the loop, and a strip of loop fastener material joined to the second side of the inside surface of the loop, wherein the opening and closing steps are performed by opening and closing the hook and loop fastener material strips. Also, in one embodiment the method comprises joining the strips of hook and loop fastener material to the first and second sides of the inside surface of the loop by stitching. In one embodiment the method comprises joining the strips of hook and loop fastener material to the first and second sides of the inside surface of the loop by a strong adhesive. And in one embodiment the closure mechanism comprises a spring metal clip having a first metal side and a second metal side in parallel intimate contact for a closure length from a first end to a second end, the first metal side and the second metal side joined together at the first end and open at the second end, the spring metal clip joined to the first and second sides of the inside surface of the loop with the first end at the pointed side of the loop and the open second end toward the rounded side of the loop, wherein the opening and closing steps are performed by pulling open the spring metal clip and allowing it to close by spring tension.

In one embodiment the method comprises joining the spring metal clip to the first and second sides of the inside surface of the loop by a strong adhesive. Also, in one embodiment the method comprises joining the first metal side and the second metal side of the spring metal clip at the first end by welding. Also, in one embodiment the method comprises forming the spring metal clip by folding a single strip of spring steel to form the wherein the first metal side and the second metal side of the spring metal clip. In one embodiment the method comprises creating a lead in enabling a user to urge a portion of an article into the open end to be held between the metal sides, by curving the metal sides at the open end away from one another. And in one embodiment the method comprises providing a hold feature formed on one or both sides, such that the portion of an article urged between the metal sides is caught at the hold feature.

### BRIEF DESCRIPTION OF THE SEVERAL VIEWS OF THE DRAWINGS

FIG. 1 is an elevation view of an article-carrying leash according to an embodiment of the present invention.

FIG. 2 is an enlarged view of the loop portion of the leash of FIG. 1.

FIG. 3 is an elevation view of the loop portion of the leash of FIG. 2 holding an article.

FIG. 4 is an elevation view of a loop portion of a leash according to another embodiment of the present invention.

FIG. 5A is a side view of the clip of FIG. 4.

FIG. 5B is an elevation view of the clip of FIG. 5A.

FIG. 5C is an enlarged view of the clip of FIG. 5A embedded in a loop holding an article.

### DETAILED DESCRIPTION OF THE INVENTION

In various embodiments described in enabling detail herein, the inventor provides a unique leash apparatus adapted for carrying one or more articles while walking an animal. The present invention is described using the following examples, which may describe more than one relevant embodiment falling within the scope of the invention.

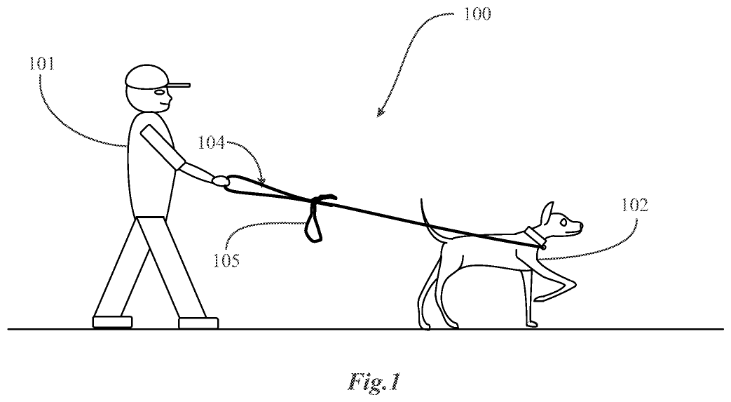

FIG. 1 is an elevation view of an article-carrying leash 100 according to an embodiment of the present invention. Leash 100 has a loop portion 104 at one end held by a user 101 in the process of walking an animal 102, in this example, a dog. Leash 100 may be of a standard leash material such as nylon or leather in a preferred embodiment and may be between five feet and fifteen feet long. The leash material may have a uniform material thickness and a uniform width and typically includes a clasp mechanism at one end to connect to a ring on a collar or harness on dog 102.

Leash 100 is characterized in this example as having loop 104, which may be formed by looping a free end of the leash back on itself and sewing or otherwise connecting the material together forming the loop. Loop 104 of leash 100 may be a foot or more in length but may have other dimensions in different embodiments.

Loop 104 of leash 100 may be adapted to hold an article 105 by suspension at a lower defined portion of loop 104. Article 105 may be a dog excrement bag, a bag of dog treats, or some other accessory article without departing from the spirit and scope of the present invention.

Article 105 may, in one embodiment, be held in the lower portion of loop 104 using an industrial strength hook and loop connection, commonly termed Velcro™ in the art, the hook material applied to one side of the inside surface of the loop while the loop material may be applied to the opposite facing side of the inside surface of the loop. In this example of the invention, one or more than one article 105 may be placed and suspended in lower loop 104 in a manner that leaves a sufficient length of loop 104 functional for use as an open loop to be held by user 101.

In use, loop 104 may be pulled apart along the length of the hook and loop material to the termination point of the loop for the purpose of placing an article such as article 105 there between, wherein the hook and loop connector may be closed around the body of the article such as, for example, the neck of a doggie bag, enabling the article to be suspended from loop 104.

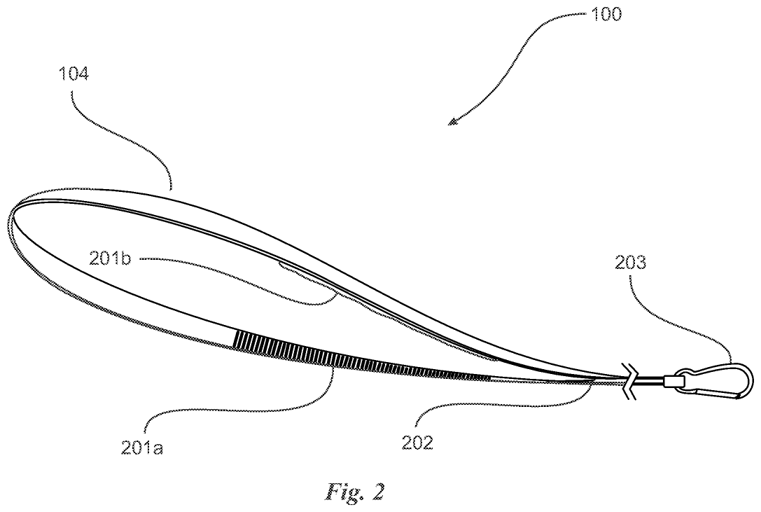

FIG. 2 is an enlarged view of loop portion 104 of leash 100 of FIG. 1, with the overall length of the leash shown in broken section. In this embodiment, loop 104 extends in length to a termination point 202. The end of the leash has a clasp mechanism 203. Clasp mechanism 203 may be any one of several types known to latch onto a ring or loop portion of a dog collar or dog harness.

Industrial hook and loop material is indicated in FIG. 2 as a strip 201a of hook material attached or otherwise fixed along a length of one material side of loop 104 ending some distance short of termination point 202, and a strip 201b of loop material attached or otherwise fixed along a length of the opposing material side of loop 104 ending at the same distance short of termination point 202. The length of the hook and loop connector strip may be up to six inches or more but may vary in different embodiments. The width of the hook and loop strips 201a and 201b may be roughly the same width as the width of underlying leash material. Strips 201a and 201b may be sewn onto leash material 103 or fastened thereto by a strong adhesive.

In one embodiment, hook and loop material strips 201a and 201b may extend to the termination point 202 of loop 104. A user may separate hook and loop strips 201a and 201b by manually pulling them apart and may close them together again around a body portion (such as the neck of a bag) of the article to be suspended. Depending on the length of strips 201a and 201b, more than one article may be suspended from loop portion 104 of leash 100 without departing from the spirit and scope of the invention.

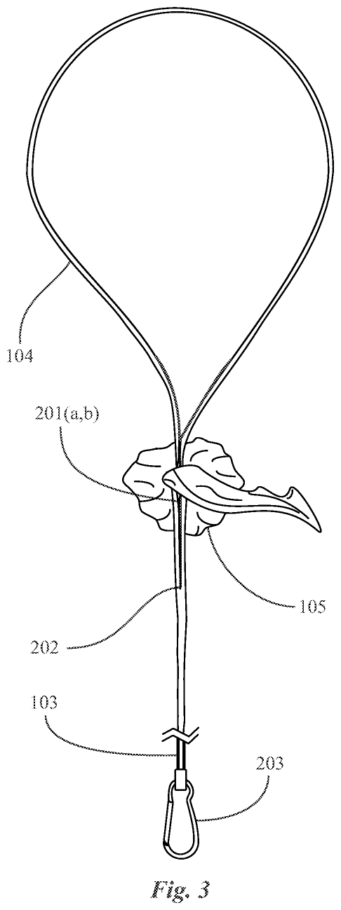

FIG. 3 is an elevation view of loop portion 104 of leash 100 of FIG. 2 holding an article 105. Loop potion 104 of leash 100 is holding article 105 via hook and loop connector 201a and 201b pressed together around the neck portion of article 105. In this view, hook and loop strips 201a and 201b remain open above the suspended article 105 and may hold a second article along with article 105. Article 105 may be placed closer to the loop termination point 202 to make room for as many articles as the length of the hoop and loop strips may allow. Hook and loop material 201a and 201b may extend further up the sides of loop 104 without departing from the spirit and scope of the invention taking much of or all the inside surfaces of material 103 defining the inside of the loop.

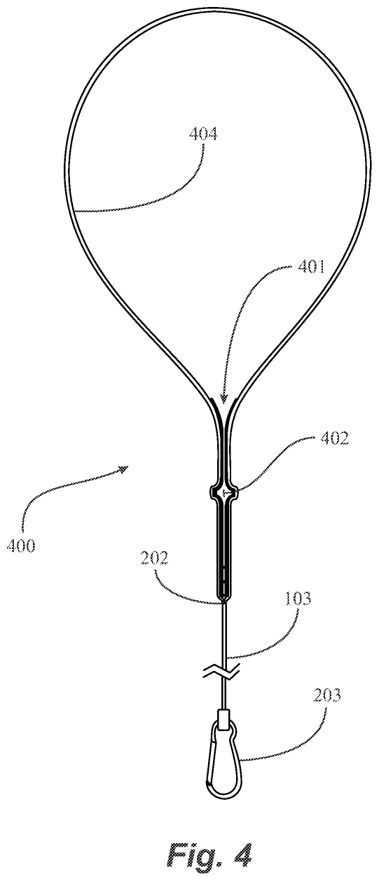

FIG. 4 is an elevation view of a loop portion 404 of a leash 400 according to an alternative embodiment of the present invention. Loop portion 404 of leash 400 may be analogous materially to loop 104 of leash 100. In this application, a spring steel clip 401 is used rather than a hook and loop arrangement. Clip 401 may be formed as one single contiguous clip having two opposing sides that assume parallel position. In one embodiment, clip 401 may be fabricated of two spring steel components welded together or otherwise fixed together at the lower part of the clip.

In this embodiment, clip 401 occupies the lower portion of loop 404 down to the loop termination point 202. Clip 401 may be glued to or otherwise bolted or riveted to the inside material surface 103 of the loop occupying the same or similar position as the hook and loop connector described further above. Spring steel clip 401 in this example has a flare at the opening of the clip adapted to accept the body portion of an article being urged into the clip body. Clip 401 in this example includes at least one symmetrical hold feature 402 disposed about halfway down clip 401 from the flared end. Hold feature 402 maybe formed to provide a hold location for clipping an article in the lower portion of loop 404 and suspending the article from the clip. In one embodiment, more than one hold feature 402 may be formed along the sides of clip 401 without departing from the spirit and scope of the present invention.

The resilience of the spring clip holds loop 404 in a closed position along the length of the clip with the flare out portion at the top of the clip adapted to enable a user to spread clip 401 apart by urging the body portion of an article such as article 105 into the clip and down the clip to hold position 402. The sides of clip 401 spread apart until the article is at hold feature 402, which encloses over the body portion when the clip springs back to original position. In this way the clip may suspend the article via the hold portion provided the body portion is larger in diameter than hold feature 402 of clip 401.

In this embodiment, a user may twist up a doggy bag and tie the bag off and urge the neck potion into the clip without being required to separate materials like hook and loop materials. Typically, the knot at the top of a bag is larger than the diameter of hold feature 402 such that if the hold did not fully clasp the neck portion, the knot would not pass through the hold feature and the article would still be firmly suspended. Hold feature 402 is, in a preferred embodiment held to a small dimension that would be smaller than the diameter of the article body portion (typically the neck portion of a bag). To remove an article from clip 401, a user like user 101 of FIG. 1 may physically spread clip 401 apart by manipulating the flared end of the clip and may remove the article from hold 402 and the clip 401.

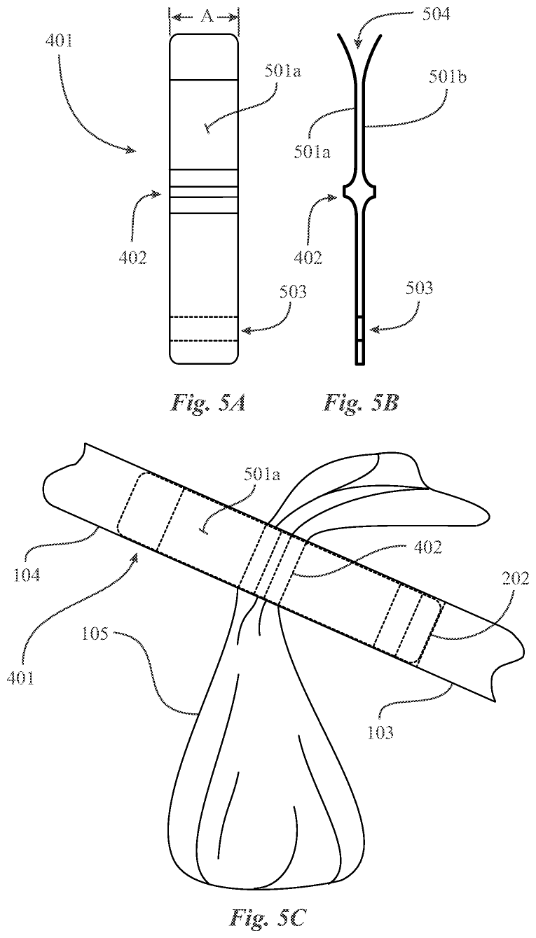

FIGS. 5A and 5B are front and side views of clip 401 of FIG. 4. Clip 401 includes two parallel sides 501a and 501b. Clip 401 has a closed end 503 that may be the result of clip 401 being formed from one bar of spring steel or from two separate bars welded together at end 503 to form the working clip. Hold feature 402 may be a symmetric form that is angular, rectangular, or triangular wherein one half of the form occupies each side of the clip. In another embodiment, hold feature 402 may occupy just one side of the spring steel clip wherein the other side has no form. In a variation of that embodiment, there may be more than one hold feature 402 as a half form spaced along the length of clip 401 whereby the half forms occupy alternate sides of clip 401 along the length of the sides.

Clip 401 may be rounded at the corners to remove any sharp edges that may cut into leash material 103. In one embodiment, clip 401 may be glued or cemented in place at the bottom of the loop. In one embodiment, the individual sides of clip 401 may be inserted into elongate sheaths sewn into the leash material for the purpose of accepting the sides of the clip there through holding the clip in place on the loop. In this embodiment, there may be clips of varying lengths that a user may swap one clip for another by removing the former from the sheaths and then inserting the latter to change the length of the clip and or to change the hold form pattern of a particular clip. Clip 401 has a width dimension A that may be the width dimension of the leash material it is attached to.

FIG. 5B is an elevation view of clip 401 of FIG. 5A. Clip 401 in a relaxed state has a parallel profile relative to clip sides 501a and 501b. The material thickness of the spring steel may be about one sixteenth of an inch uniform thickness. The gap between clip sides 501a and 501b may be about one eighth of an inch or less down to a negligible gap between the sides. The open end 504 of clip 401 is radiused out to provide a no-catch spring expansion mechanism that automatically opens the clip upon the urging of a body portion of an article to be clamped by the clip. In one embodiment, open end 504 includes a straight-line bend at each of the clip side ends as opposed to a radius.

In one embodiment of the present invention, clip sides 501a and 501b do not have a hold feature that clips over a body portion of an article to be suspended. Rather, the inside surfaces of side 501a and or side 501b of the spring steel clip 401 may be gnarled or may otherwise include small protrusions that are raised above the surface to grip the body of an article to be suspended in a form like an “alligator” style clip without departing from the spirit and scope of the present invention.

FIG. 5C is an enlarged side view of clip 401 of FIG. 5A embedded in a loop holding an article. Clip 401 is depicted on the inside and at the bottom end of loop 104 cut off at the upper left in the view. Clip 401 abuts the termination point 202 of loop 104 at the lower left in the view. Leash material 103 is cut off in this view past loop termination point 202. In a non-tensioned or relaxed state, clip 401 holds article 105 in a state of suspension wherein the body portion of article 104 is clamped over by form 402.

It will be apparent tom a person with skill in the art that the article-carrying animal leash of the present invention may be provided using some or all the elements described herein. The arrangement of elements and functionality thereof relative to the article-carrying leash in embodiments of the invention is described in different embodiments each of which is an implementation of the present invention. While the uses and methods are described in enabling detail herein, it is to be noted that many alterations could be made in the details of the construction and the arrangement of the elements without departing from the spirit and scope of this invention. The present invention is limited only by the breadth of the claims below.

1. A leash, comprising:
a length of leash material folded back at a first end and joined to itself, forming a loop having an inside surface rounded on one side and converging to a point on an opposite side, with leash material extending from the loop to a second end;
a clasp mechanism joined at the second end, adapted to clip to a collar or a harness of an animal; and
a closure mechanism implemented in the loop, adapted to urge one side of the inside surface of the loop for a closure distance from the pointed end to the rounded end into intimate contact with a second side of the inside surface of the loop for the closure distance;
characterized in that a user of the leash is enabled to open the first and second sides of the inside surface of the loop, place an article between the open sides, and to close the sides again around the article, holding the article suspended, and is enabled to open the sides of the inside surface of the loop to remove the suspended article.

2. The leash of claim 1 wherein the closure mechanism comprises a strip of hook fastener material joined to the first side of the inside surface of the loop, and a strip of loop fastener material joined to the second side of the inside surface of the loop, wherein the opening and closing is accomplished by the action of the hook and loop fastener material strips.

3. The leash of claim 2 wherein the strips of hook and loop faster material are joined to the first and second sides of the inside surface of the loop by stitching.

4. The leash of claim 2 wherein the strips of hook and loop faster material are joined to the first and second sides of the inside surface of the loop by a strong adhesive.

5. The leash of claim 1 wherein the closure mechanism comprises a spring metal clip having a first metal side and a second metal side in parallel intimate contact for a closure length from a first end to a second end, the first metal side and the second metal side joined together at the first end and open at the second end, the spring metal clip joined to the first and second sides of the inside surface of the loop with the first end at the pointed side of the loop and the open second end toward the rounded side of the loop.

6. The leash of claim 5 wherein the spring metal clip is joined to the first and second sides of the inside surface of the loop by a strong adhesive.

7. The leash of claim 5 wherein the first metal side and the second metal side of the spring metal clip are joined at the first end by welding.

8. The leash of claim 5 wherein the first metal side and the second metal side of the spring metal clip are a single strip of spring steel folded at the first end forming the two metal sides in parallel intimate contact.

9. The leash of claim 5 wherein the metal sides of the spring metal clip at the open end curve away from one another providing a lead in enabling a user to urge a portion of an article into the open end to be held between the metal sides.

10. The leash of claim 9 wherein one metal side of the spring metal clip is formed to provide a hold feature, such that the portion of an article urged between the metal sides is caught at the hold feature.

11. A method for carrying an article with a leash, comprising:
forming a leash by folding a length of leash material back at a first end and joining the first end to the leash material, forming a loop having an inside surface rounded on one side and converging to a point on an opposite side, with leash material extending from the loop to a second end;
attaching a clasp mechanism at a second end, adapted to clip to a collar or a harness of an animal;
implementing a closure mechanism in the loop, the closure mechanism adapted to urge one side of the inside surface of the loop for a closure distance from the pointed end to the rounded end into intimate contact with a second side of the inside surface of the loop for the closure distance;
opening the first and second sides of the inside surface of the loop;
placing a portion of an article between the open sides; and
closing the sides again around the article, holding the article suspended.

12. The method of claim 11 wherein the closure mechanism comprises a strip of hook fastener material joined to the first side of the inside surface of the loop, and a strip of loop fastener material joined to the second side of the inside surface of the loop, wherein the opening and closing steps are performed by opening and closing the hook and loop fastener material strips.

13. The method of claim 12 comprising joining the strips of hook and loop fastener material to the first and second sides of the inside surface of the loop by stitching.

14. The method of claim 12 joining the strips of hook and loop fastener material to the first and second sides of the inside surface of the loop by a strong adhesive.

15. The method of claim 11 wherein the closure mechanism comprises a spring metal clip having a first metal side and a second metal side in parallel intimate contact for a closure length from a first end to a second end, the first metal side and the second metal side joined together at the first end and open at the second end, the spring metal clip joined to the first and second sides of the inside surface of the loop with the first end at the pointed side of the loop and the open second end toward the rounded side of the loop, wherein the opening and closing steps are performed by pulling open the spring metal clip and allowing it to close by spring tension.

16. The method of claim 15 comprising joining the spring metal clip to the first and second sides of the inside surface of the loop by a strong adhesive.

17. The method of claim 15 comprising joining the first metal side and the second metal side of the spring metal clip at the first end by welding.

18. The method of claim 15 comprising forming the spring metal clip by folding a single strip of spring steel to form the wherein the first metal side and the second metal side of the spring metal clip.

19. The method of claim 15 comprising creating a lead in enabling a user to urge a portion of an article into the open end to be held between the metal sides, by curving the metal sides at the open end away from one another.

20. The method of claim 19 comprising providing a hold feature formed on one or both sides, such that the portion of an article urged between the metal sides is caught at the hold feature.
